(19) United States
(12) Patent Application Publication
(10) Pub. No.: US 2006/0031382 A1
(43) Pub. Date: Feb. 9, 2006

(54) System and method for translating fully qualified domain name access in a browser environment

(76) Inventors: Arvind Pradhakar, San Josse, CA (US); Rajeev Angal, San Jose, CA (US); Pirasenna Velandai Thiyagarajan, San Jose, CA (US); James Frederick Nelson, Danville, CA (US)

Correspondence Address: OSHA LIANG L.L.P./SUN, 1221 MCKINNEY, SUITE 2800, HOUSTON, TX, 77010, US

(21) Appl. No.: 10/618,035

(22) Filed: Jun. 4, 2004

(51) Int. Cl. G06F 15/16

(52) U.S. Cl. 709/217

(57) ABSTRACT

A computer system having a user specified web browsing system for selectively translating user defined uniform resource locator addresses specified in a cookie is disclosed. A memory stored mapping is disclosed which maps URLs to corresponding fully qualified domain names. A web page translator will automatically translate a user web access request such that its corresponding fully qualified domain name is used.

### RELATED U.S. APPLICATION

This application claims priority to the copending provisional patent application Ser. No. ______, Attorney Docket Number SUN-P030XXX.PRO, entitled “System and Method for Translating Fully Qualified Domain Name Access in a Browser Environment,” filed Jul. 10, 2003, assigned to the assignee of the present application, and hereby incorporated by reference in its entirety.

### FIELD OF THE INVENTION

The present claimed invention relates generally to the field of information processing systems. More particularly, embodiments of the present claimed invention relates to web-based access translation in a browser environment.

### BACKGROUND ART

The World Wide Web (the “web”) provides a popular source of information for consumers and business users. Surfing the web has become appealing to both sophisticated and casual users. The web browser has therefore become the primary means of accessing data over the Internet. However, one of the major problems is that the user must go out and search for data for a variety of web sites. If there are 20 web sites a user is interested in, the user must look at each site to see if there have been any interesting changes since the last visit. Even then, if additional content is added to the site after the visit, the user will not find out until the user returns to the site again.

In accessing these web sites, a user uses qualified domain names to access different host systems to define desired information on the Internet. Fully qualified domain name (FQDN) is the complete domain name for a specific computer (host) on the Internet. It provides enough information so that it can be converted into a physical IP address to the web server. The FQDN consists of host name and domain name. For example, www.sun.com is the FQDN for the web of Sun Microsystems™. The WWW is the host, Sun is the domain name and .Com is the top level domain name.

To preserve their web preferences, many users configure cookies with URLs to track the web sites and applications they frequent. Cookies are data created by a web server that is stored in a user's computer either temporarily for a particular session or permanently on hard disk. The cookies provide a way for a web site to identify users and their preferences. Cookies typically contain a range of URLs (addresses) for which they are valid. These addresses typically are the FQDNs of the web site the user visits. When a web browser or other HTTP application sends a request to a web server with those URLs again, it also sends along the related cookies. For example, if a user's user_id and password are stored in a cookie, it saves the user from typing in the same information all over again when accessing that service the next time to the same web site.

FIG. 1 is an exemplary block diagram illustration of a typical cookie configuration to a browser in the prior art. In the illustration in FIG. 1, a user typically, accesses web sites 120-150 via web browser 110. In FIG. 1, the user can access web site 120-150 by accessing each individual web site to access the data the user desires by using two independently configured cookies 112 and 115. The browser 110 uses the two separate cookies 112 and 115 to access the web sites 120-150.

In the example shown in FIG. 1, although the two cookies 112 and 115 are independently configured by the user to point to the same web server 100, the contents of each cookie is invisible to the other. Thus, although the two cookies 112 and 115 contain the same URLs that point to the same FQDN, the information will be invisible between the two cookies. Consequently, if the user, when accessing the web sites 120-150, mis-types information to any of the cookies 112 and 115 that is inconsistent with FQDN stored in a particular cookie, access to the desired web site is denied and the cookie hangs up. In a distributed computer system where user authentication to applications is usually required in order to prevent unauthorised accesses to the computer network, having such cookie hangups can create a bottleneck to system availability. This also means that the user has to remember the contents of each cookie or the entire FQDN of a site to a site in order to ensure that the user can always access the site with cookies being activated.

A problem occurs because users can type different but similar domain names to search the same web location. For instances, one can type www.netscape.com or “netscape.com” to arrive at the same web location. In this case, different cookies are defined, one for each domain name syntax, although both are directed to the same web location. These cookies are not visible to each other.

Thus, for the prior art in which a user configures cookies to view content from multiple web sites, the user needs to always remember the FQDNs configured in cookies in order to be able to access specific content from each web site to retrieve the content desired without any interruption or denial of service.

### SUMMARY OF INVENTION

Accordingly, to take advantage of the myriad of web-sites and content on the Internet, there is a need for a system and method with extensible capabilities to allow a user to manage user preferences to specified web sites without any interruption in the translation of web addresses and without requiring the user to manually memorize all the addresses configured into cookies used by the user to browse these specified web sites. A need exists for “out-of-the-box” web content delivery system solutions to allow a whole range of end-users to connect to the Internet environment and have content continuously delivered to them without unduly tasking the end-user with the need to continuously reconfigure their search mechanism. In particular, a need exists for a system that normalizes a user's request to the same web location although different but similar domain names are used to fetch that location so that cookies defined for this location are used. The system is transparent to the user.

Embodiments of the present invention are directed to a system and a method for translating URLs defined in cookies to a variety of web sites in a web server in a computer network environment. In general, embodiments of the present invention vary the degree of providing user access to predefined URLs to the web environment by implementing uniform translation of the URLs to eliminate any inconsistencies in real-time URL access information by the user specified to the same web sites. In other words, one embodiment of the invention provides automatic user specific URL translation in an Internet browser environment. In one embodiment, the URL translator translates the user specified URL to the matching fully qualified domain name of the target web location. In this way, cookies for the web location are always defined in the name of the FQDN and the browser always goes to the FQDN regardless of the URL used by the user.

Embodiments of the invention also include an Internet browser that is user programmed to dynamically retrieve updated content from specified web sites for delivery to the user. The browser periodically queries web pages at different web sites according to a user defined configuration file to retrieve content from these web sites. The Internet browser detects changes in the predefined URLs from a current user provided URL and reconciles the differences without denying the user access to the predefined address.

Embodiments of the present invention also include a URL redirection module for redirecting inconsistent URLs configured in user cookies to default predefined FQDNs specified by the user to desired web sites. The URL redirection logic allows the browser to reconcile user URL entries with predefined default URLs pre-configured in existing user cookies to allow the user access to desired web applications or web sites.

Embodiments of the present invention further include URL mapping logic that automatically matches mis-typed URL entries to logically defined FQDNs to the web applications or sites the user wishes to access. The mapping logic enables user to use aliases to predefined FQDNs in the user cookies.

Embodiments of the present invention further include request monitoring module for tracking user access to web pages. The monitoring module allows the present invention to determine whether a user provided URL corresponds with URLs pre-stored in user defined cookies that tracks the user's preferred web applications or web sites.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

Prior Art FIG. 1 is a block diagram of a conventional Internet browser system;

FIG. 2 is a system level block diagram of an embodiment of the present invention;

FIG. 3 is a block diagram of an exemplary internal architecture of the browsing FQDNs consolidator of the present invention; and

FIG. 4 is an exemplary computer implemented flow diagram depiction of the URL resolution in an embodiment of the present invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended Claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

The invention is directed to a system, an architecture, subsystem and method to manage user URL definitions and translations in a device independent browser environment in a way superior to the prior art. In accordance with an aspect of the invention, a computer system provides a translation service for user defined URLs by reconciling the URLs to predefined FQDNs to a variety of web sites and web applications.

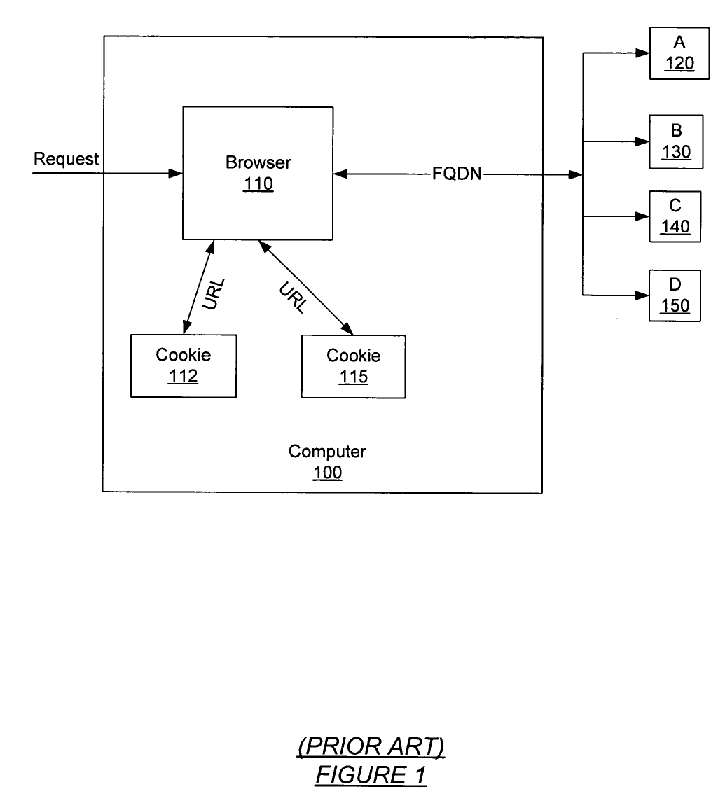

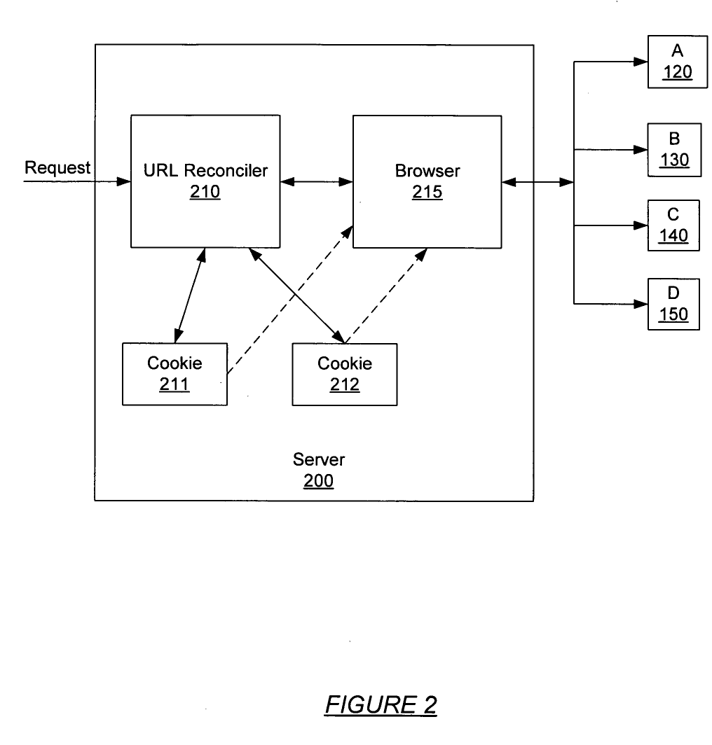

Embodiments of the invention are more fully described with reference to FIGS. 2 through 4.

FIG. 2 is a block diagram depiction of one embodiment of the Internet browsing environment of the present invention. As shown in FIG. 2, the Internet browsing environment 200 of the present invention comprises computer server 200 having a browser 215, a URL reconciler 210 “control unit”, user configured cookies 211 and 212 and web sites 120-150. Any well known browser can be used.

In the web browser environment shown in FIG. 2, the URL reconciler 210 functions as a URL translator in the computer server 200 to provide reconciled uniform URLs to predefined FQDNs defined in the cookies 211 and 212. In one embodiment of the present invention, cookies 211 and 212 point to the same FQDNs on the web server 200, but may have the different URLs defined. However, the information defined in each cookie may be invisible to the other. For example, the FQDN: www.cnn.com may be defined as the common FQDN for cookies 211 and 212. However, cookie 211 may have the URL: www.cnn.com defined and cookie 212 may have the URL “cnn.com” defined. If the user wishing to access the FQDN: www.cnn.com issues a hypertext transport protocol (HTTP) request using cookie 212, under the prior art, such a request will fail. However, in one embodiment of the present invention, the URL reconciler 210 takes the URL defined in cookie 212 and reconciles it to the FQDN: www.cnn.com in a manner that is transparent to the user. In such way, the cookies 211 and 212 are defined for the FQDN version of this exemplary site.

The URL reconciler 210 includes components that periodically query web pages 120-150 according to the user defined cookie 211 and 212. The URL reconciler 210 detects changes (updates) in the specified web sites and summarizes those changes and delivers it to the user.

In one embodiment of the present invention, the URL reconciler 210 is able to accept mistyped or invalid URL information to the predefined web pages 120-150 and reconcile the mistyped information with, the matching predefined FQDN information stored in the cookies 211 and 212. This is done transparently to the user.

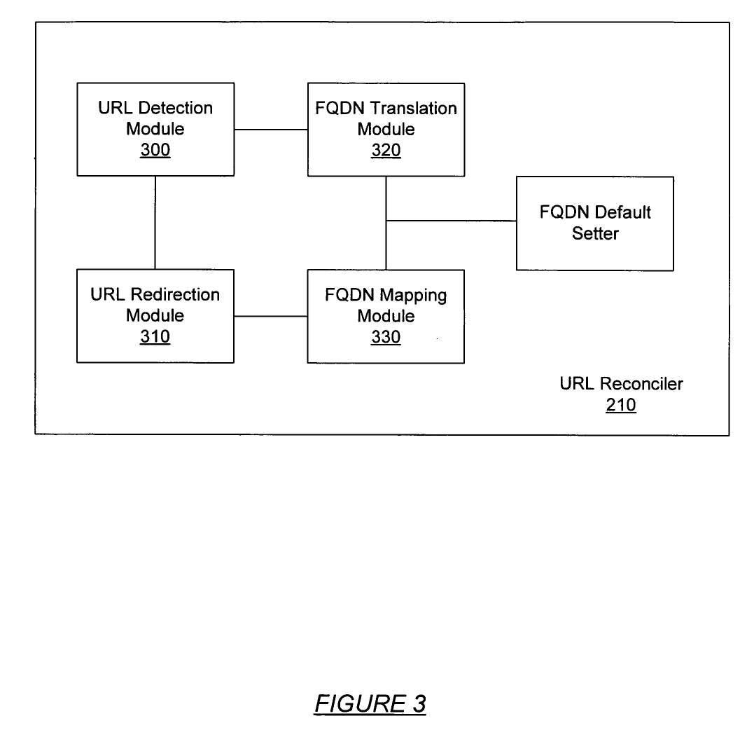

FIG. 3 is a block diagram illustration of one embodiment of the URL reconciler 210 of the present invention. URL reconciler 210 comprises URL detection module 300, URL redirection module 310, FQDN translation module 320, FQDN mapping module 330 and FQDN default setter module 340. The URL reconciler 210 also couples to web sites 120-150 (FIG. 2) to retrieve content requested by the user connecting to the browser 215.

The URL detection module 300 provides detection logic to enable the URL reconciler 210 to detect changes between FQDNs defined in a user's cookie and the URLs provided in a user's HTTP request as the user access the web sites 120-150 (FIG. 2). The URL detection module 300 tracks a user's entry to access the defined FQDNs. If the user presents an invalid URL e.g., one that is inconsistent with the predefined URLs in the user's cookies, the URL detection module 300 transmits the invalid information to the redirection module 310, but signals invalid URL.

The URL redirection module 310 accepts user accepted URLs from the URL detection module 300 and redirects the invalid URLs provided by the user to access a web site to the correct FQDN. The redirection module 310 redirects all user provided real-time URL information to the FQDN translation module 320 which stores a list of predefined FQDNs in the server 200.

The FQDN translation module 320 translates any invalid URL presented to the URL reconciler 210 as a result of a user mistyping access request to the web sites 120-150 (FIG. 2) or the user using defined aliases to URLs defined in the user's cookie. The FQDN translation module 320 automatically and transparently maps the invalid URL information to the correct FQDNs defined in the server 200. The mapping module 330 handles all mapping of invalid URLs to valid FQDNs in the URL reconciler 210. In one embodiment of the present invention, FQDN translation module 320 is dynamically updatable to extend the list of predefined FQDNs stored in the server 200.

In one embodiment of the present invention, if the mapping module 330 is unable to map an invalid URL to any of the predefined FQDNs in the server 210, the URL is mapped to a default FQDN that is predefined by the FQDN default setter 340. An embodiment of the present invention also provides an alias process in which user created URL aliases are mapped by the mapping module 330 to valid FQDNs defined in the web server 200. Table 1 illustrates an exemplary alias process of the mapping module 330 and represents mapping information that is stored in computer readable memories of the mapping module 330.

TABLE 1
FQDN MAP

| ALIAS | URL | FQDN |
|---|---|---|
| foo | foo.com | www.foo.com |
| bar | bar.com | www.bar.com |
| hr | sun.hr.com | www.sun.hr.com |
| fo | foo.com | www.foo.com |
| IP address | IP address.com | www.IP address.com |

In the example illustrated in Table 1, the user could configure a cookie with the URLs that correspond to the predefined FQDN. The user could then issue HTTP requests using the alias to the URLs defined in the cookie. The URL reconciler 210 takes any of the HTTP alias requests and translates the alias according to the predefined URL and corresponding FQDN as found in mapping Table 1. In one embodiment of the present invention, the URL reconciler 210 is configurable to identify a set of invalid URLs that may be reconcilable to valid predefined FQDNs in the server 200 (FIG. 2). The URL reconciler 210 may also be configured to include or exclude various invalid names that may be reconciled in the web server 200.

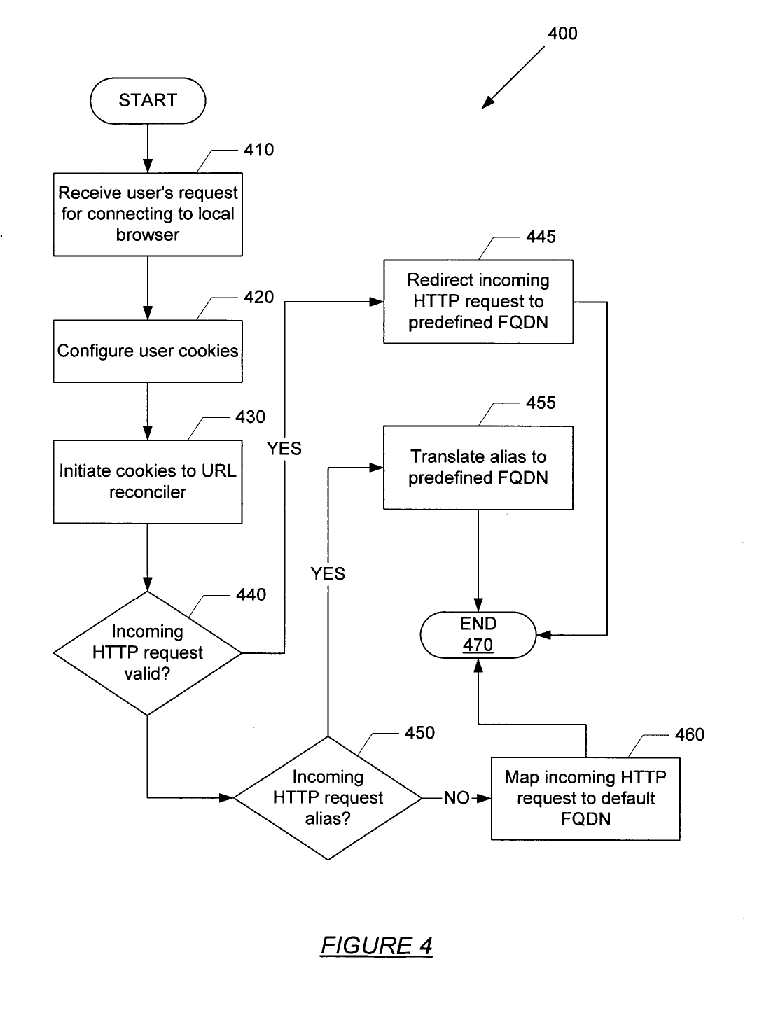

Reference is now made to FIG. 4 which is a computer implemented flow diagram of the operation of one embodiment of the present invention. The URL translation process of one embodiment of the present invention is initiated at 400 when the user connects 410 to a local browser. At step 420, the user configures a plurality of cookies to specify the web sites and associated content that the user wishes to track. At step 420, the cookies may be automatically defined by a browser in response to a user interfacing with a web site.

At step 430, the user defined cookies are initiated and the URL reconciler 210 receives a HTTP request via the user defined cookies e.g., www.foo.com. In one embodiment of the present invention, the HTTP request may or may not have a valid URL address e.g., “foo” or “foo.com”. At step 440, the URL reconciler 210 checks the incoming user HTTP request to determine whether the cookie specifies a valid URL e.g., “foo.com”. If a valid URL is specified that matches a predefined FQDN to the web server, the URL is automatically translated to the FQDN that matches the URL therefore the URL is redirected to the predefined FQDN, e.g., “www.foo.com” that corresponds to the incoming URL at step 445.

At step 450, if the incoming HTTP request does not have a valid URL that the URL reconciler could redirect to a predefined FQDN, e.g., “foo”, the URL reconciler 210 checks to determine whether the incoming HTTP request is an alias of a predefined FQDN, e.g., “www.foo.com”. If the URL reconciler 210 determines that the incoming HTTP request is an alias of a predefined FQDN, the URL reconciler translates the alias to the corresponding FQDN, e.g., “www.foo.com” at step 455.

If the incoming HTTP request is an invalid URL or is not a defined alias, e.g., “h” in the web server, the URL reconciler 210 maps the incoming HTTP request to a default predefined FQDN, e.g., “www.sun.hr.com” at step 460 and processing terminates at step 470.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications that are suited to the particular use contemplated. It is intended that the scope of the invention be defined by the Claims appended hereto and their equivalents.

1. A computer system comprising:
a web browser for browsing web sites on the Internet;
a plurality of user defined data storage units having similarly defined but independently invisible address information to said web sites; and
a web address translation system for translating user web access request addresses to said web sites to corresponding predefined fully qualified domain names.

2. The computer system of claim 1, wherein said web address translation system detects address differences between a user web access request address and a predefined fully qualified domain name.

3. The computer system of claim 1, wherein said user web access request address contains an invalid access address to said web sites.

4. The computer system of claim 1, wherein said web address translation system comprises an address detection module for automatically determining whether said incoming user web access request address comprises a valid address mappable to a predefined fully qualified domain name.

5. The computer system of claim 4, wherein said web address translation system further comprises an address redirection unit for redirecting invalid address in said plurality of user defined data storage units to said predefined fully qualified domain names.

6. The computer system of claim 5, wherein said web address translation system further comprises a fully qualified domain name translation module for translating invalid addresses in said user web access request address to valid predefined fully qualified domain names.

7. The computer system of claim 6, wherein said user web access request address comprise Uniform Resource Locator (URL) addresses and wherein said web address translation system further comprises a fully qualified domain name mapping module for mapping invalid addresses to said valid predefined fully qualified domain names.

8. The computer system of claim 7, wherein said web address translation system further comprises a fully qualified domain name default setting module for setting a default fully qualified domain name to which said invalid URL maps.

9. The computer system of claim 1, wherein said plurality of user defined data storage units are cookies.

10. The computer system of claim 8, wherein said web address translation system further comprises address aliasing process for translating user defined web address aliases into said predefined fully qualified domain names.

11. A browser system, comprising:
a data collection module for automatically searching a plurality of user defined web sites to detect and retrieve content; and
a web address translation unit for translating uniform resource locator addresses into corresponding predefined fully qualified domain names.

12. The browser system of claim 11, wherein said web address translation unit reconciles address differences between said uniform resource locator addresses and said predefined fully qualified domain names.

13. The browser system of claim 11, wherein said uniform resource locator addresses contain invalid access address to corresponding web sites.

14. The browser system of claim 12, wherein said web address translation unit comprises an address detection module for automatically determining whether said uniform resource locator addresses comprise valid addresses mappable to said predefined fully qualified domain names.

15. The browser system of claim 13, wherein said web address translation unit further comprises an address redirection unit for redirecting said invalid addresses to said predefined fully qualified domain names.

16. The browser system of claim 15, wherein said web address translation unit further comprises a fully qualified domain name translation module for translating invalid addresses in said uniform resource locator addresses to corresponding predefined fully qualified domain names.

17. The browser system of claim 16, wherein said web address translation unit further comprises a fully qualified domain name mapping module for mapping invalid uniform resource locator addresses to said corresponding predefined fully qualified domain names.

18. The browser system of claim 17, wherein said web address translation unit further comprises a fully qualified domain name default setting module for setting a default fully qualified domain name to which said invalid uniform resource locator addresses maps.

19. The browser system of claim 18, wherein said web address translation unit further comprises address aliasing process for translating user defined web address aliases into said predefined fully qualified domain names.

20. The browser system of claim 11, wherein said data collection module is a cookie.

21. A web browser comprising:
a plurality of user defined data storage units each comprising contents that are invisible to the other units; and
an addressing reconciliation system for reconciling address differences between uniform resource locator addresses and predefined fully qualified domain names.

22. The web browser of claim 21, wherein said plurality of user defined data storage units store a plurality of said uniform resource locator addresses.

23. The web browser of claim 21, wherein said address reconciliation system comprises detection logic for automatically detecting address differences between said uniform resource locator addresses and incoming HTTP request addresses from a user and to said web browser.

24. The web browser of claim 23, wherein said address reconciliation unit further comprises an address detection module for automatically determining whether said uniform resource locator addresses comprise valid addresses mappable to said predefined fully qualified domain names.

25. The web browser of claim 24, wherein said address reconciliation system further comprises an address redirection unit for redirecting invalid address in said plurality of data storage units to ones of said predefined fully qualified domain names.

26. The web browser of claim 25, wherein said address reconciliation system further comprises a fully qualified domain name translation module for translating invalid addresses in said uniform resource locator addresses to valid predefined fully qualified domain names.

27. A computer implemented method of translating Internet access addresses, comprising:
defining a plurality of web address storage units;
defining a plurality of fully qualified domain names corresponding to a plurality of web addresses; and
translating incoming HTTP request addresses to corresponding fully qualified domain names.

28. The method of claim 27, wherein said translating comprises detecting address differences between an incoming HTTP request address and a corresponding predefined fully qualified domain name.

29. The method of claim 28, wherein said translating further comprises translating said HTTP request address to a web address stored in said plurality of web address storage units.

30. The method of claim 29, wherein said plurality of web address storage units are cookies.
